(19) United States
(12) Patent Application Publication
(10) Pub. No.: US 2024/0326489 A1
(43) Pub. Date: Oct. 3, 2024

(54) PRINTING APPARATUS

(71) Applicant: SEIKO EPSON CORPORATION, Tokyo (JP)

(72) Inventor: Kenichi HIRABAYASHI, SHIOJIRI-SHI (JP)

(21) Appl. No.: 18/616,509

(22) Filed: Mar. 26, 2024

(30) Foreign Application Priority Data
Mar. 29, 2023 (JP) 2023-052913

(51) Int. Cl. B41J 29/02; B41J 2/165; B41J 2/17; B41J 29/13

(52) U.S. Cl. CPC B41J 29/02; B41J 2/16508; B41J 2/1721; B41J 29/13

(57) ABSTRACT

A printing apparatus includes a medium storage unit that stores a medium, a printing unit including a print head that forms an image on the medium, a medium conveyance unit that conveys the medium toward the print head, an ink storage unit that stores ink, a housing internally accommodating the medium storage unit, the printing unit, the medium conveyance unit, and the ink storage unit, and an operation panel configured to instruct formation of the image on the medium. The housing includes an opening/closing portion opened/closed when the medium is stored in the medium storage unit, an opening/closing portion opened/closed when the ink is stored in the ink storage unit, and an opening/closing portion opened/closed when the print head is accessed. Handhold portions at which a hand is put when the opening/closing portions are opened/closed, and the operation panel are disposed at the same surface of the housing.

The present application is based on, and claims priority from JP Application Serial Number 2023-052913, filed Mar. 29, 2023, the disclosure of which is hereby incorporated by reference herein in its entirety.

### BACKGROUND

### 1. Technical Field

The present disclosure relates to a printing apparatus configured to form an image on a medium.

### 2. Related Art

JP-A-2016-60555 describes a printer that performs, with a print head, printing on roll paper disposed in a housing and discharges the printed roll paper from a paper ejection port to the outside of the housing. The housing of this printer has a substantially cuboid shape, and an operation panel is disposed next to a paper ejection port on a front surface of the housing. The operation panel includes an operation button operated by the user and a display that provides the user with information.

However, in the printer described in JP-A-2016-60555, the roll paper is disposed at the rear of the housing, and roll paper replacement requires opening/closing of an opening/closing lid provided on a side surface different from the front surface. That is, upon recognizing the need of replacement of the roll paper based on the information displayed on the display of the operation panel, the user has to move from a position facing the front surface of the housing to a position facing another side surface in order to replace the roll paper. Therefore, it is necessary to improve work efficiency in replacing roll paper or the like.

### SUMMARY

A printing apparatus includes: a medium storage unit configured to store a print medium, a printing unit including an image forming unit configured to form an image on the print medium, a medium conveyance unit configured to convey the print medium stored in the medium storage unit toward the image forming unit, an image forming member storage unit configured to accommodate an image forming member to be applied to the print medium by the image forming unit when the image is formed, a housing internally accommodating the medium storage unit, the printing unit, the medium conveyance unit, and the image forming member storage unit, and an operation unit including a display portion, provided integrally with or separately from the housing, and configured to instruct formation of the image on the print medium, in which the housing includes a first opening/closing portion opened/closed when the print medium is stored in the medium storage unit, a second opening/closing portion opened/closed when the image forming member is stored in the image forming member storage unit, and a third opening/closing portion opened/closed when the image forming unit is accessed from an outside of the housing, and a first handhold portion at which a hand is put when the first opening/closing portion is opened/closed, a second handhold portion at which a hand is put when the second opening/closing portion is opened/closed, a third handhold portion at which a hand is put when the third opening/closing portion is opened/closed, and the operation unit are disposed at the same surface of the housing.

### BRIEF DESCRIPTION OF THE DRAWINGS

FIG. 1 is a perspective view illustrating a printing apparatus.

FIG. 2 is a perspective view illustrating the printing apparatus in a state where an opening/closing portion is opened.

FIG. 3 is a configuration diagram illustrating a schematic configuration of the printing apparatus.

FIG. 4 is a perspective view illustrating a frame disposed inside a housing.

### DESCRIPTION OF EMBODIMENTS

Hereinafter, a printing apparatus 1 of the present embodiment will be described with reference to the drawings. The printing apparatus 1 of the present embodiment is, for example, an inkjet type printer configured to form a character or an image such as a photograph on a medium M by ejecting ink, which is an example of liquid, onto the medium M that is a print target. The type of the medium M is not particularly limited, but in the present embodiment, the medium M wound in a roll shape is used. Note that the medium M corresponds to the print medium. The ink applied to the medium M when an image is formed corresponds to the image forming member.

Each figure illustrates X-, Y-, and Z-axes that intersect with one another. Typically, the X-, Y-, and Z-axes are orthogonal to one another. The X-axis is parallel to the installation surface of the printing apparatus 1, and corresponds to the width direction of the printing apparatus 1. The Y-axis is parallel to the installation surface of the printing apparatus 1, and corresponds to the depth direction of the printing apparatus 1. The Z-axis is perpendicular to the installation surface of the printing apparatus 1, and corresponds to the height direction of the printing apparatus 1.

Hereinafter, a +X direction parallel to the X-axis is a leftward direction toward the front of the printing apparatus 1, and a-X direction parallel to the X-axis is a direction opposite to the +X direction. The +Y direction parallel to the Y-axis is a direction from the back toward the front of the printing apparatus 1, and a-Y direction parallel to the Y-axis is a direction opposite to the +Y direction. A+Z direction parallel to the Z-axis is an upward direction, and a-Z direction parallel to the Z-axis is a direction opposite to the +Z direction.

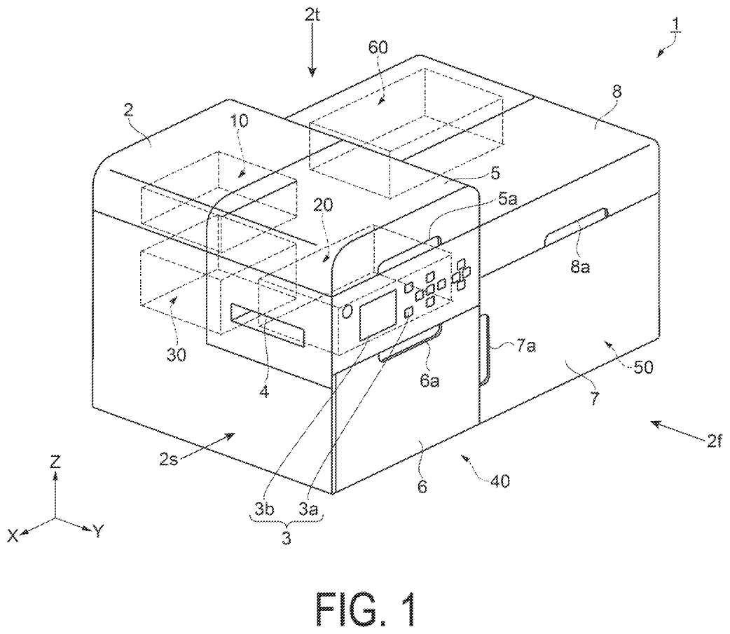

FIG. 1 is a perspective view illustrating the printing apparatus 1 of the present embodiment.

As illustrated in FIG. 1, the printing apparatus 1 includes a housing 2 having a substantially cuboid shape configured to accommodate an apparatus main body. The printing apparatus 1 further includes a printing unit 10, a medium conveyance unit 20, a maintenance unit 30, an ink storage unit 40, a medium storage unit 50, and a control unit 60 inside the housing 2. That is, the housing 2 constitutes an exterior of the printing apparatus 1, and internally accommodates the printing unit 10, the medium conveyance unit 20, the maintenance unit 30, the ink storage unit 40, the medium storage unit 50, and the control unit 60.

An operation panel 3 is disposed on a front surface 2f facing the +Y direction among the surfaces of the housing 2. In the present embodiment, the operation panel 3 is provided integrally with the housing 2. The operation panel 3 includes a plurality of operation buttons 3a configured to receive user operations, and a display portion 3b configured to display various types of information. By using the operation panel 3, the user can instruct the control unit 60, for example, to form an image on the medium M and perform various settings. The operation panel 3 corresponds to the operation unit. Of the surfaces of the housing 2, a side surface 2s facing the +X direction is provided with a paper ejection port 4 through which the medium M after the image is formed is discharged.

The housing 2 includes a plurality of opening/closing portions 5, 6, 7, and 8. Among them, the opening/closing portion 5 is disposed above the operation panel 3, that is, in the +Z direction, and the opening/closing portion 6 is disposed below the operation panel 3, that is, in the −Z direction. The opening/closing portion 7 is disposed on the right side of the opening/closing portion 6, that is, in the −X direction, toward the front surface 2f, and the opening/closing portion 8 is disposed above the opening/closing portion 7. The opening/closing portion 5 and the opening/closing portion 8 constitute a top surface 2t facing the +Z direction among the surfaces of the housing 2, and the opening/closing portion 6 and the opening/closing portion 7 constitute the front surface 2f of the housing 2.

Each of the opening/closing portions 5, 6, 7, and 8 can be opened/closed in a door-like manner, and the inside of the housing 2 can be accessed by opening the opening/closing portions 5, 6, 7, and 8. The opening/closing portions 5, 6, 7, and 8 are formed with handhold portions 5a, 6a, 7a, and 8a, respectively, to which a hand is put when the opening/closing portions 5, 6, 7, or 8, respectively, are opened/closed. The handhold portions 5a, 6a, 7a, and 8a are formed by cutting out a part of the opening/closing portions 5, 6, 7, and 8 in a concave shape, and are configured to receive a hand of the user. In the present embodiment, the handhold portions 5a, 6a, 7a, and 8a are provided on the front surface 2f of the housing 2 as with the operation panel 3. In other words, the handhold portions 5a, 6a, 7a, and 8a and the operation panel 3 are disposed on the same surface of the housing 2.

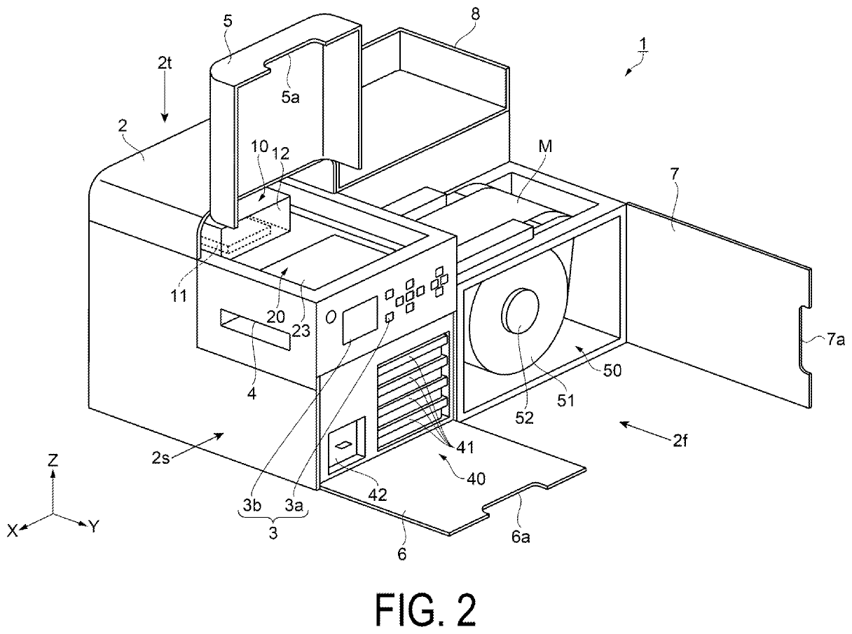

FIG. 2 is a perspective view illustrating the printing apparatus 1 in a state where the opening/closing portions 5, 6, 7, and 8 are opened.

As illustrated in FIG. 2, the opening/closing portion 5 can be opened by lifting the handhold portion 5a upward and then moving the handhold portion 5a backward. When the opening/closing portion 5 is opened, the medium conveyance unit 20 configured to convey the medium M toward the paper ejection port 4 is exposed. Thus, the medium conveyance unit 20 can be accessed by opening the opening/closing portion 5. Opening the opening/closing portion 5 also enables access to the print head 11 described later. That is, the opening/closing portion 5 is opened/closed when the medium conveyance unit 20 or the print head 11 is accessed from the outside of the housing 2. The opening/closing portion 5 corresponds to the third opening/closing portion, and the handhold portion 5a of the opening/closing portion 5 corresponds to the third handhold portion.

The opening/closing portion 6 can be opened by pulling out the handhold portion 6a forward and then moving the handhold portion 6a downward. When the opening/closing portion 6 is opened, the ink storage unit 40 and a waste liquid tank 42 are exposed. The ink storage unit 40 stores an ink cartridge 41 accommodating ink, and the waste liquid tank 42 stores waste ink described later. Thus, the ink storage unit 40 and the waste liquid tank 42 can be accessed by opening the opening/closing portion 6. For example, the opening/closing portion 6 is opened/closed when the ink cartridge 41 of the ink storage unit 40 is replaced. In other words, the opening/closing portion 6 is opened/closed when the ink is stored in the ink storage unit 40. The opening/closing portion 6 is opened/closed when the waste liquid tank 42 is replaced, that is, when the waste ink stored in the waste liquid tank 42 is removed. The ink storage unit 40 corresponds to the image forming member storage unit, and the waste liquid tank 42 corresponds to the waste material storage unit. The opening/closing portion 6 corresponds to the second opening/closing portion, and the handhold portion 6a of the opening/closing portion 6 corresponds to the second handhold portion.

The opening/closing portion 7 can be opened by pulling out the handhold portion 7a forward and then moving the handhold portion 7a rightward. When the opening/closing portion 7 is opened, the medium storage unit 50 configured to be mounted with the medium M is exposed. The medium storage unit 50 stores a roll body 51 that is the medium M wound in a roll shape. Specifically, a rotation shaft 52 configured to rotate with respect to the housing 2 is disposed in the medium storage unit 50, and the roll body 51 is mounted to the rotation shaft 52. That is, the opening/closing portion 7 is opened/closed when the roll body 51, that is, the medium M is stored in the medium storage unit 50. The opening/closing portion 7 corresponds to the first opening/closing portion, and the handhold portion 7a of the opening/closing portion 7 corresponds to the first handhold portion.

The opening/closing portion 8 can be opened by lifting the handhold portion 8a upward and then moving the handhold portion 8a backward. When the opening/closing portion 8 is opened, a conveyance path through which the medium M pulled out from the roll body 51 is conveyed is exposed. The opening/closing portion 8 is opened/closed, for example, when the medium M pulled out from the roll body 51 is inserted into the medium conveyance unit 20.

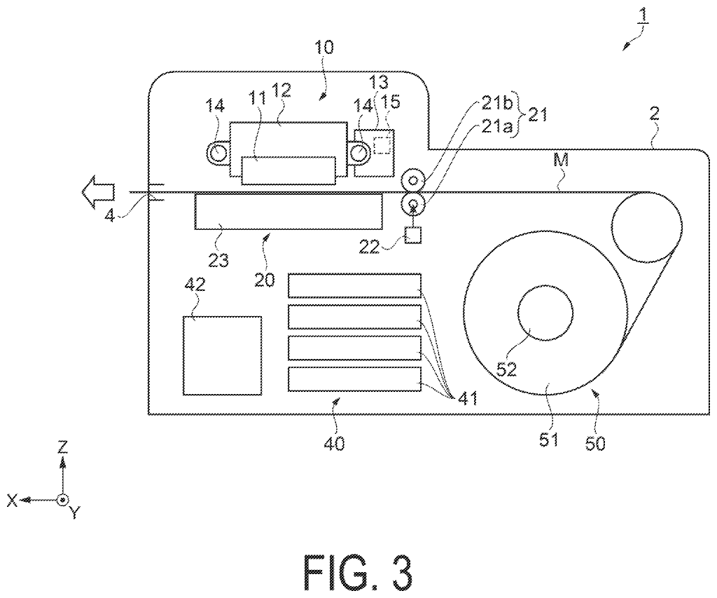

FIG. 3 is a configuration diagram illustrating a schematic configuration of the printing apparatus 1, and is a view of the inside of the housing 2 viewed from the front.

As illustrated in FIG. 3, the printing unit 10 includes a print head 11, a carriage 12, and a carriage driving unit 13. The print head 11 is replaceably attached to the carriage 12. The print head 11 is an inkjet head configured to form an image on the medium M by ejecting ink. Specifically, the print head 11 includes a piezo actuator, and ejects ink downward from a nozzle formed on a lower surface by driving the piezo actuator under the control of the control unit 60. The print head 11 of the present embodiment is a line head in which a large number of nozzles are formed over the entire region in a width direction of the medium M, that is, the +Y direction. The print head 11 corresponds to the image forming unit.

The print head 11 is supplied with a control signal from the control unit 60 via a flexible flat cable (FFC) (not illustrated) or the like. The print head 11 is supplied with the ink accommodated in the ink cartridge 41 through a flexible ink tube (not illustrated) or the like.

The carriage 12 supports the print head 11 and is movable in a front-rear direction, that is, the +Y direction. Specifically, both left and right sides of the carriage 12, that is, both sides in the +X direction are provided with a pair of guide shafts 14 extending in the +Y direction, and the carriage 12 is guided by the guide shaft 14 to move in the +Y direction. The guide shaft 14 is fixed with respect to the housing 2.

The carriage 12 is coupled to the carriage driving unit 13 and moves in the +Y direction by driving of the carriage driving unit 13. The carriage driving unit 13 includes a pair of timing pulleys (not illustrated), a timing belt having an annular shape (not illustrated), and a carriage driving motor 15 that operates under the control of the control unit 60. The pair of timing pulleys is disposed in the vicinity of both ends in the +Y direction of the guide shaft 14 on the −X side. The timing belt is stretched over the pair of timing pulleys, and a part thereof is coupled to the carriage 12. Torque from an output shaft of the carriage driving motor 15 is transmitted to one of the timing pulleys via a transmission. When the control unit 60 drives the carriage driving motor 15, one of the timing pulleys rotates, and the timing belt is circularly driven. Due to this, the carriage 12 coupled to the timing belt moves in the +Y direction along the guide shaft 14.

Thus, since the carriage 12 is movable in the +Y direction, the carriage 12 can switch, inside the housing 2, between a state of being positioned at a home position on the −Y side and a state of being positioned at a printing position on the +Y side. When the carriage 12 is in the printing position, the print head 11 overlaps the medium conveyance unit 20 in plan view viewed from the +Z direction. Printing on the medium M is performed when the carriage 12 is in the printing position. Note that as described above, since the print head 11 of the present embodiment is a line head in which a large number of nozzles are formed over the entire region in the width direction of the medium M, it is not necessary to move the print head 11 in the +Y direction during printing.

On the other hand, when the carriage 12 is in the home position, the print head 11 does not overlap the medium conveyance unit 20 but overlaps the maintenance unit 30 in plan view. The maintenance unit 30 includes a cap configured to cover the nozzle of the print head 11, and protects and performs maintenance of the print head 11 under the control of the control unit 60. For example, the control unit 60 executes flushing for forcibly ejecting ink from the print head 11 regardless of printing, thereby removing foreign matters, air bubbles, deteriorated ink, or the like in the nozzle. In this case, the maintenance unit 30 receives the ink ejected from the print head 11 and discharges the ink to the waste liquid tank 42 as waste ink. Note that the waste ink is, of the ink accommodated in the ink cartridge 41, ink having not been used for formation of an image, and corresponds to the waste material. The carriage driving unit 13 moves the print head 11 together with the carriage 12 between the medium conveyance unit 20 and the maintenance unit 30, and thus corresponds to the moving unit.

The roll body 51 around which the medium M is wound is stored in the medium storage unit 50. The medium storage unit 50 is positioned on the −X side relative to the carriage 12 in the printing position. The medium M is pulled out from the roll body 51 and delivered to the medium conveyance unit 20 positioned in the +X direction.

The medium conveyance unit 20 includes a conveyance roller pair 21, a conveyance motor 22, and a medium support portion 23. The medium conveyance unit 20 conveys, toward the print head 11, the medium M pulled out from the roll body 51 stored in the medium storage unit 50. The conveyance roller pair 21 includes a driving roller 21a positioned on the −Z side and a driven roller 21b positioned on the +Z side. The conveyance motor 22 rotates the driving roller 21a under the control of the control unit 60. The driven roller 21b is biased toward the driving roller 21a, and the medium M is sandwiched between the driving roller 21a and the driven roller 21b and fed in the +X direction by the driving of the conveyance motor 22.

The medium support portion 23 supports the medium M conveyed in the +X direction by the conveyance roller pair 21. When the carriage 12 is in the printing position, the medium support portion 23 faces the print head 11 across the medium M. The medium M is supported by the medium support portion 23, and receives ejection of ink from the print head 11 while being conveyed in the +X direction that is the conveyance direction by the conveyance roller pair 21. The medium M on which an image is formed by ejection of ink is discharged from the paper ejection port 4 to the outside of the housing 2.

The ink storage unit 40 in which a plurality of ink cartridges 41 are stored and the waste liquid tank 42 are disposed below the medium conveyance unit 20. The ink cartridge 41 of the present embodiment includes four ink cartridges 41 accommodating inks of four colors of yellow, magenta, cyan, and black. The waste ink discharged from the maintenance unit 30 is stored in the waste liquid tank 42.

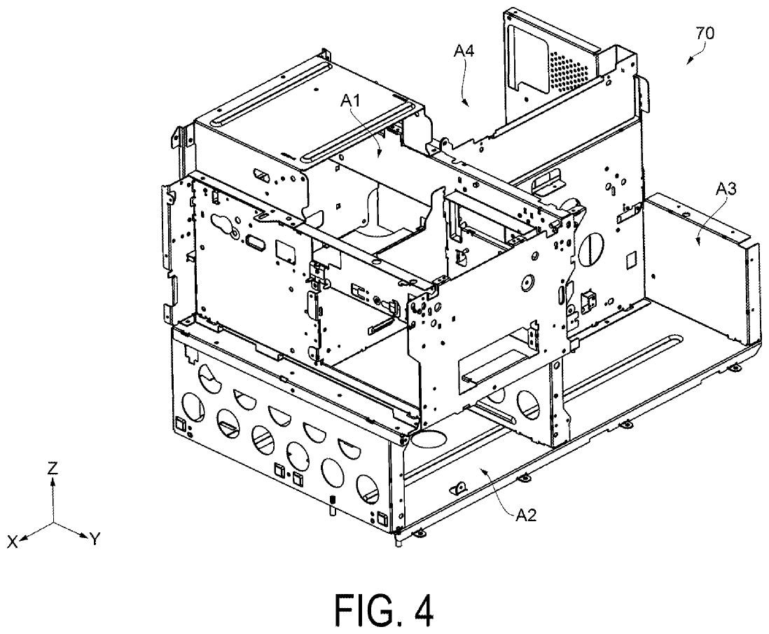

FIG. 4 is a perspective view illustrating a frame 70 disposed inside the housing 2.

The printing apparatus 1 includes the frame 70 supporting the apparatus main body inside the housing 2. As illustrated in FIG. 4, the frame 70 is formed of a plurality of metal plate-like members. The frame 70 partitions areas where the above-described components are disposed, such as the printing unit 10, the medium conveyance unit 20, the maintenance unit 30, the ink storage unit 40, the medium storage unit 50, and the control unit 60, and supports the disposed components. Specifically, the frame 70 partitions the space inside the housing 2 into a plurality of areas including a first area A1, a second area A2, a third area A3, and a fourth area A4.

The first area A1 is an area positioned on the +X side and the +Z side in the housing 2, and extends in the +Y direction. The first area A1 stores the printing unit 10, the medium conveyance unit 20, and the maintenance unit 30. The printing unit 10, the medium conveyance unit 20, and the maintenance unit 30 are unitized in advance, and disposed in the first area A1 as one unit. That is, the printing unit 10, the medium conveyance unit 20, and the maintenance unit 30 are attached to the frame 70 in a state of being assembled in advance with an appropriate positional relationship with one another. Therefore, as compared with the configuration in which the printing unit 10, the medium conveyance unit 20, and the maintenance unit 30 are individually attached to the frame 70, the printing accuracy is improved, and the rigidity of the printing apparatus 1 is improved.

The second area A2 is an area positioned on the +X side and the −Z side in the housing 2, and extends in the +Y direction. That is, the second area A2 is positioned below the first area A1. The ink storage unit 40 and the waste liquid tank 42 are disposed in the second area A2. That is, the ink storage unit 40 and the waste liquid tank 42 are disposed in the second area A2 different from the first area A1. Since the ink storage unit 40 and the waste liquid tank 42 are disposed in the lower portion in the housing 2, even if the ink leaks from the ink storage unit 40 and the waste liquid tank 42, damage to the other components and the medium M by the leaked ink is suppressed.

The third area A3 is an area positioned on the −X side and the +Y side in the housing 2. That is, the third area A3 is positioned on the −X side of the first area A1 and the second area A2. The third area A3 stores the roll body 51. That is, the third area A3 constitutes the medium storage unit 50.

The fourth area A4 is an area positioned on the −X side and the −Y side in the housing 2. That is, the fourth area A4 is positioned on the −X side of the first area A1 and the second area A2 and at the rear of the third area A3, that is, in the −Y direction. The control unit 60, a power supply unit (not illustrated), and the like are disposed in the fourth area A4.

In the printing apparatus 1 configured as described above, when an error such as insufficient remaining amount of consumables such as the medium M or ink occurs, the user recognizes the occurrence of the error based on the information displayed on the display portion 3b of the operation panel 3. Then, when an error occurs, the user opens any of the opening/closing portions 5, 6, 7, and 8, accesses the inside of the housing 2, and resolves the error.

For example, when the remaining amount of any ink becomes insufficient, the user opens the opening/closing portion 6 and replaces the corresponding ink cartridge 41 with a new one. Similarly, when the amount of waste ink stored in the waste liquid tank 42 reaches an upper limit value, the user opens the opening/closing portion 6 and replaces the waste liquid tank 42.

When the medium M stored in the medium storage unit 50 runs out, the user opens the opening/closing portion 7 and stores a new roll body 51 in the medium storage unit 50. Furthermore, the user opens the opening/closing portion 8 and inserts, into the medium conveyance unit 20, the medium M pulled out from the roll body 51.

When clogging of the medium M, that is, a jam of the medium M occurs in the medium conveyance unit 20, the user opens the opening/closing portion 5 and removes the clogged medium M. The user opens the opening/closing portion 8 as necessary and reinserts the medium M into the medium conveyance unit 20.

When a foreign matter, deteriorated ink, or the like is clogged in the nozzle of the print head 11 and the clogging is not resolved by flushing using the maintenance unit 30, the print head 11 is replaced. In this case, the user can replace the print head 11 by opening the opening/closing portion 5 and moving the carriage 12 to the printing position, that is, above the medium conveyance unit 20. Thus, in the present embodiment, since the print head 11 is accessible via the opening/closing portion 5, replacement of the print head 11 does not require disassembly of the housing 2 or the frame 70, and work can be efficiently performed.

When the print head 11 is replaced, the FFC, the ink tube, and the like is removed from the old print head 11 and re-attached to the new print head 11. In the present embodiment, a plurality of members to be accessed when the print head 11 is replaced, such as the print head 11, the FFC, and the ink tube, are disposed in the first area A1. Thus, replacement of the print head 11 can be more efficiently performed as compared with when such plurality of members are disposed in different areas, respectively. When the print head 11 is replaced, the opening/closing portion 5 may be opened after the carriage 12 is moved to the printing position under the control of the control unit 60.

Upon finishing the error resolution work as described above, the user operates the operation button 3a of the operation panel 3 to restart printing.

As described above, the handhold portions 5a, 6a, 7a, and 8a of the opening/closing portions 5, 6, 7, and 8 are disposed on the front surface 2f of the housing 2 as with the operation panel 3. For this reason, the user can execute, on the front surface 2f side of the housing 2, almost all operations from recognition of an error by the display portion 3b to error resolution work and restart of printing. This eliminates the need for movement to another side surface side of the housing 2, and enables a series of work to be efficiently carried out.

As described above, according to the printing apparatus 1 of the present embodiment, the following effects can be obtained.

According to the present embodiment, the printing apparatus 1 includes the opening/closing portion 7 opened/closed when the medium M, that is, the roll body 51 is stored, the opening/closing portion 6 opened/closed when the ink cartridge 41 is stored, and the opening/closing portion 5 opened/closed when the printing unit 10 is accessed. The handhold portions 5a, 6a, and 7a of the respective opening/closing portions 5, 6, and 7 are provided on the same surface as that of the operation panel 3. Therefore, the user that operates the operation panel 3 can open/close the opening/closing portions 5, 6, and 7 and access the inside while being in front of the surface provided with the operation panel 3, and thus the work efficiency of the user is improved.

According to the present embodiment, since the medium conveyance unit 20 can be accessed by opening the opening/closing portion 5, even when a defect such as a jam of the medium M occurs in the medium conveyance unit 20, the defect can be easily resolved.

According to the present embodiment, a plurality of members to be accessed when the print head 11 is replaced, such as the print head 11, the FFC, and the ink tube, are all disposed in the first area A1. This enables replacement of the print head 11 to be efficiently performed as compared with when such plurality of members are disposed in different areas, respectively.

According to the present embodiment, since the ink storage unit 40 and the waste liquid tank 42 are disposed in the same second area A2 and can be accessed by opening the opening/closing portion 6, work such as replacement of the ink cartridge 41 and the waste liquid tank 42 can be easily performed.

According to the present embodiment, both the ink storage unit 40 that stores ink and the waste liquid tank 42 that stores waste ink are disposed below the first area A1 in which the printing unit 10 and the medium conveyance unit 20 are disposed. Therefore, even if the ink leaks from the second area A2, damage to the print head 11 and the medium M can be suppressed.

According to the present embodiment, the printing unit 10, the medium conveyance unit 20, and the maintenance unit 30 are unitized and disposed in the first area A1. Therefore, the printing accuracy and the rigidity of the printing apparatus 1 can be improved as compared with when the printing unit 10, the medium conveyance unit 20, and the maintenance unit 30 are individually disposed.

The above embodiment may be changed as follows.

In the above embodiment, the liquid ejected by the print head 11 is not limited to ink. For example, the print head 11 may eject a liquid body containing, in a dispersed or dissolved state, a material such as an electrode material or a coloring material used for manufacturing various displays.

In the above embodiment, an aspect in which the ink cartridge 41 accommodating ink is stored in the printing apparatus 1 is described, but an aspect in which ink is poured into a tank included in the printing apparatus 1 may be adopted. In this case, the tank that accommodates the ink corresponds to the image forming member storage unit.

In the above embodiment, the print head 11 is constituted by a line head, but is not limited to this configuration. For example, the print head 11 may be a serial head, and may have a configuration of ejecting ink while moving the carriage 12 in the +Y direction.

In the above embodiment, the printing apparatus 1 is not limited to the inkjet type. For example, the printing apparatus 1 may be a thermal type in which the ink applied to an ink ribbon is transferred to the medium M by a thermal head. In this case, the ink applied to the ink ribbon corresponds to the image forming member, and the thermal head corresponds to the image forming unit. A portion configured to store the ink ribbon in the housing 2 corresponds to the image forming member storage unit. The printing apparatus 1 may be a laser type that transfers toner accommodated in a cartridge or the like to the medium M using a photoreceptor. In this case, the toner corresponds to the image forming member, and the photoreceptor corresponds to the image forming unit. In the housing 2, a portion configured to store the cartridge accommodating the toner corresponds to the image forming member storage unit.

In the above embodiment, the operation panel 3 may be separable from the housing 2. That is, the operation panel 3 may have a configuration in which the operation panel 3 is provided separately from the housing 2 and a state of being mounted at a predetermined position of the housing 2 and a state of being separated from the predetermined position can be selected as appropriate. In this case, among the surfaces of the housing 2, a surface having the predetermined position at which the operation panel 3 is to be mounted corresponds to the surface on which the operation panel 3 is disposed.

In the above embodiment, a configuration in which the operation panel 3 includes the operation button 3a and the display portion 3b has been described, but the present disclosure is not limited to this configuration. For example, the operation panel 3 may include a touchscreen in which a transparent touch sensor is superimposed on the display portion 3b. The display portion 3b may be configured to display an image, such as a liquid crystal display device or an organic electroluminescence (EL) display device, or may be configured to notify an occurrence of an error by turning on or blinking a light-emitting body such as a light-emitting diode.

In the above embodiment, the handhold portions 5a, 6a, 7a, and 8a are not limited to have the configuration formed in a concave shape. For example, the handhold portions 5a, 6a, 7a, and 8a may have a configuration formed in a convex shape like a handle.

In the above embodiment, an aspect in which the medium M is supplied to the printing apparatus 1 as the roll body 51 is described, but the supply aspect of the medium M is not limited to the above. For example, an aspect in which a cassette on which the sheet-like medium M is loaded is supplied to the printing apparatus 1 or an aspect in which the sheet-like medium M is manually supplied may be adopted. The material of the medium M is not particularly limited, and various materials such as paper, textiles such as cloth and woven fabric, and vinyl chloride resin can be adopted.

What is claimed is:

1. A printing apparatus comprising:
a medium storage unit configured to store a print medium;
a printing unit including an image forming unit configured to form an image on the print medium;
a medium conveyance unit configured to convey the print medium stored in the medium storage unit toward the image forming unit;
an image forming member storage unit configured to accommodate an image forming member to be applied to the print medium by the image forming unit when the image is formed;
a housing internally accommodating the medium storage unit, the printing unit, the medium conveyance unit, and the image forming member storage unit; and
an operation unit including a display portion, provided integrally with or separately from the housing, and configured to instruct formation of the image on the print medium, wherein
the housing includes
a first opening/closing portion opened/closed when the print medium is stored in the medium storage unit,
a second opening/closing portion opened/closed when the image forming member is stored in the image forming member storage unit, and
a third opening/closing portion opened/closed when the image forming unit is accessed from an outside of the housing and
a first handhold portion at which a hand is put when the first opening/closing portion is opened/closed, a second handhold portion at which a hand is put when the second opening/closing portion is opened/closed, a third handhold portion at which a hand is put when the third opening/closing portion is opened/closed, and the operation unit are disposed at the same surface of the housing.

2. The printing apparatus according to claim 1, wherein
opening the third opening/closing portion enables access to the medium conveyance unit.

3. The printing apparatus according to claim 1, further comprising
a frame partitioning a space inside the housing into a plurality of areas, wherein
the image forming unit is replaceably included in the printing unit and
a plurality of members to be accessed when the image forming unit is replaced are disposed in a first area of the plurality of areas.

4. The printing apparatus according to claim 3, further comprising
a waste material storage unit configured to store, of the image forming member, waste material that was not used for formation of the image, wherein
the image forming member storage unit and the waste material storage unit are disposed in a second area of the plurality of areas, the second area being different from the first area, and
opening the second opening/closing portion enables access to the waste material storage unit.

5. The printing apparatus according to claim 4, wherein
the image forming member is ink,
the image forming unit is an inkjet head configured to eject the ink,
the waste material is waste ink that was not used for formation of the image, and
the second area is positioned below the first area.

6. The printing apparatus according to claim 3, further comprising
a maintenance unit configured to perform maintenance of the image forming unit, wherein
the printing unit includes a moving unit configured to move the image forming unit between the medium conveyance unit and the maintenance unit and
the printing unit, the medium conveyance unit, and the maintenance unit are unitized and disposed in the first area.
